(19) United States
(12) Patent Application Publication
(10) Pub. No.: US 2015/0363049 A1
(43) Pub. Date: Dec. 17, 2015

(54) SYSTEM AND METHOD FOR REDUCED-SIZE MENU RIBBON

(71) Applicant: Siemens Product Lifecycle Management Software Inc., Plano, TX (US)

(72) Inventors: Siarhei Sadouski, Irvine, CA (US); Michael Brown, Lakewood, CA (US); Daniel Sicking, Lakewood, CA (US); Dick Baardse, Geldermalsen (NL)

(21) Appl. No.: 14/513,679

(22) Filed: Oct. 14, 2014

Related U.S. Application Data
(60) Provisional application No. 62/012,278, filed on Jun. 14, 2014.

(51) Int. Cl. G06F 3/0482; H04N 5/445; G06F 3/0481; G06F 3/041; G06F 3/0488

(52) U.S. Cl. CPC G06F 3/0482; G06F 3/0412; G06F 3/04883; G06F 3/04817; H04N 5/44543; G06F 2203/04101; G06F 2203/04807; G06F 2203/04808

(57) ABSTRACT

Methods for converting a menu ribbon interface and corresponding systems and computer-readable mediums. A method includes executing an application. The method includes receiving a selection of a first menu ribbon to convert and converting the first menu ribbon to produce a reduced-size menu ribbon. The method includes displaying the reduced-size menu ribbon in the application.

### CROSS-REFERENCE TO OTHER APPLICATION

This application claims the benefit of the filing date of U.S. Provisional Patent Application 62/012,278, filed Jun. 14, 2014, for “System and Method for Reduced-Size Menu Ribbon,” which is hereby incorporated by reference.

### TECHNICAL FIELD

The present disclosure is related to interacting with a touch screen computer program, including, but not limited to, those directed to computer-aided design, visualization, and manufacturing systems (“CAD/CAM systems”), product lifecycle management (“PLM”) systems, and similar systems, that manage data for products and other items (collectively, “Product Data Management” systems or PDM systems).

### BACKGROUND OF THE DISCLOSURE

Interaction with a User Interface (UI) that uses a ribbon style layout can be cumbersome in reduced-sized computing devices, including, but not limited to, smart phones, mobile phones, mobile devices, tablets, etc. Improved systems are desirable.

### SUMMARY OF THE DISCLOSURE

Various disclosed embodiments include methods and systems for converting a menu ribbon interface and corresponding systems and computer-readable mediums. A method includes executing an application. The method includes receiving a selection of a first menu ribbon to convert and converting the first menu ribbon to produce a reduced-size menu ribbon. The method includes displaying the reduced-size menu ribbon in the application.

Various disclosed embodiments include systems and methods for simplified presentations of a ribbon-style user interface that presents the same predefined list of user interface elements as the full ribbon but in a reduced area and with less clutter. Numerous benefits exist, including but not limited to, the ability for the user to better interact with the ribbon system on a reduced-size computer display device.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates an exemplary full-size ribbon that can be received and processed by a data processing system as disclosed herein;

FIG. 3 illustrates an embodiment of a reduced-size slim ribbon using the methods and systems illustrated herein;

FIG. 4 illustrates an embodiment of a full-size ribbon where the scaling reduces the icons so that they can be moved from one row to two or three rows, in accordance with disclosed embodiments;

FIG. 5 illustrates an embodiment of a reduced-size slim ribbon using reduced-size small icons, repositioned for compact display, in accordance with disclosed embodiments;

FIG. 6 illustrates a full-size ribbon where groups are collapsed to a single icon with a popup ribbon layout in accordance with disclosed embodiments;

FIG. 7 illustrates an embodiment of a reduced-size slim ribbon wherein groups are collapsed to a single icon in accordance with disclosed embodiments; and

FIG. 8 illustrates a flowchart of a process in accordance with disclosed embodiments.

### DETAILED DESCRIPTION

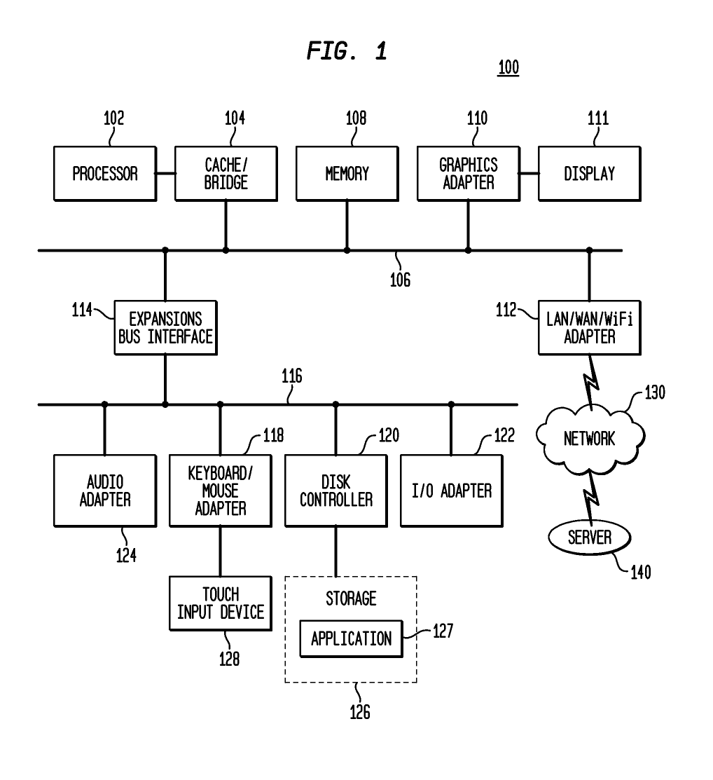

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Interaction with complex computer programs is difficult and cumbersome when operated on a mobile device or tablet device (such as one including a touch screen) for reasons including but not limited to, the limited space on which a user can interact with numerous menu choices. Ribbon style user interfaces can be used to present tabbed toolbars of user interface elements, each with varying sizes of icons and text. These interfaces work well for large monitors but consume too much space on smaller touch-enabled devices or in applications that need to maximize space for non-user interface content.

Disclosed embodiments include a ribbon-style user interface that presents the same predefined list of user interface elements as the full ribbon but in a reduced area and with less clutter. Disclosed embodiments provide a convenient, intuitive user interface operation that allows navigation of such a ribbon using a touch-based input. In order to be intuitive, the interaction can also provide visual feedback that conveys the result of user interaction. Ideally, interacting can be simple to perform using touch input and feel as if it is a natural interaction with a physical object. An interaction input may be via a user's finger or other pointing device, such as a stylus, on a touchscreen, touchpad, or similar input.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 can store an application 127 that is executed by processor 102 as described herein to convert menu ribbons and display them on display 111.

Also connected to I/O bus 116 in the example shown is audio adapter 124, to which speakers (not shown) may be connected for playing sounds. Keyboard/mouse adapter 118 provides a connection for a pointing device, such as a mouse, trackball, or otherwise, and specifically can connect to a touch input device 128 such as a trackpointer, touchscreen, touchpad, etc. The touch input device, in some embodiments, can be integrated with the display 111, for example as a touchscreen.

Those of ordinary skill in the art will appreciate that the hardware depicted in FIG. 1 may vary for particular implementations. For example, other peripheral devices, such as an optical disk drive and the like, also may be used in addition to or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Interaction with complex computer programs is difficult and cumbersome when operated on a reduced-size computer display device, such as a mobile phone, mobile device, smart phone, tablet, laptop, etc., including those having a touch screen, for reasons including but not limited to, the limited space on which a user can interact with numerous menu choices. It is highly desirable to provide a convenient, intuitive user interface operation that allows better viewing of a ribbon-based menu system.

The embodiments illustrated herein provide a ribbon-style menu system for interacting with a computer program, wherein the ribbon-style menu system is reduced in size while still providing the ability for the user to interact therewith.

For example, in an illustrative embodiment, a ribbon's height is reduced due to novel scaling (resizing) mechanisms that dynamically switch menu item size from normal to small and combines smaller menu items into columns with two rows (although two rows are illustrated, additional rows are contemplated).

In another illustrative embodiment, the ribbon includes the option to adjust the size of all menu items uniformly based on the original pixel size, 100%, 150%, etc.

In another illustrative embodiment, the menu items are grouped together as the layout width adjusts, resizing menu items evenly across different groupings to maintain a consistent relative location.

In another illustrative embodiment, groups of menu items collapse or expand depending upon available layout space reducing to a single menu item that displays a popup of the fully expanded representation.

In another illustrative embodiment, grouped menu items include the title of the group at the bottom of the group.

In another illustrative embodiment, the positioning of menu ribbon content (commands, galleries, groups) and ribbon tabs are changed to show them centered. This provides a consistent, easy to access location.

In another illustrative embodiment, the content of the ribbon is not arranged independently of the original ribbon configuration but rather inherits from it directly allowing the existing ribbon users to understand where content is located without re-learning the interface layout.

In another illustrative embodiment, a switch between slim ribbons and regular ribbon systems can be done at will and the choice can be stored/retrieved in a user preference profile.

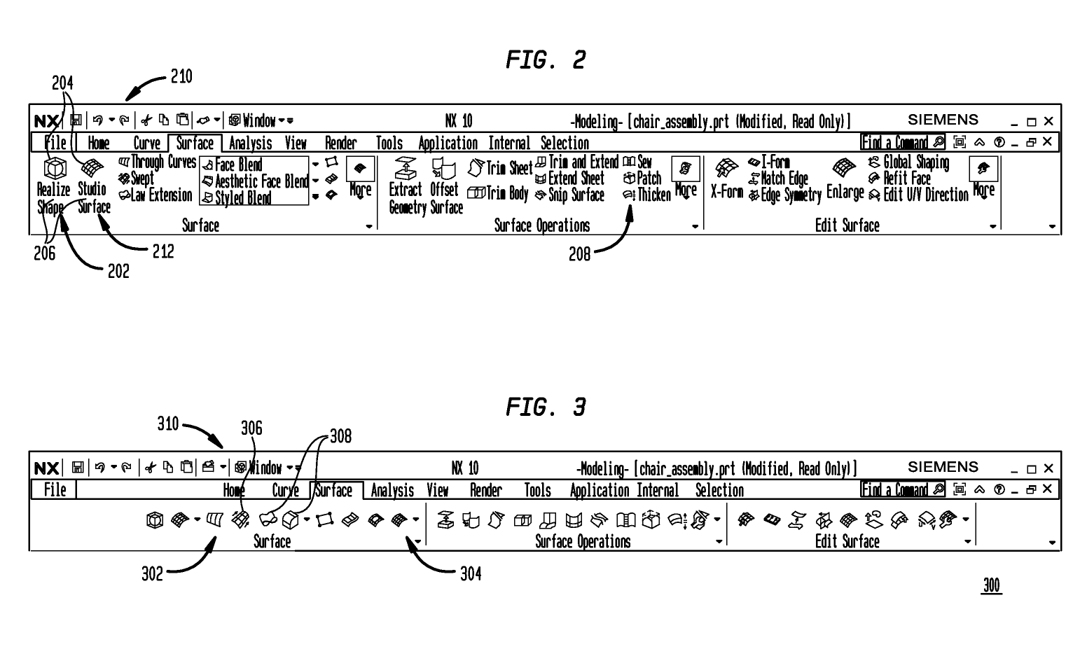

FIG. 2 illustrates an exemplary full-size ribbon 210 that can be received and processed by a data processing system as disclosed herein. Note, in this example, that various menu items, such as menu items 202 and 212, have both an icon 204 and a label 206, and the icons can be relatively large in the space of the ribbon 210. Note further that groups 208 of selections are shown, and are “stacked” three selections high in the ribbon. Such features can cause a ribbon to be too large to be practical on a smaller display.

FIG. 3 illustrates an embodiment of a reduced-size slim ribbon using the methods and systems illustrated herein. This figure illustrates a slim ribbon 310 in a user interface 300 of a display, such as display 111. In this example, note that the menu items 302 have been converted to an icon-only representation, with reduced-size icons in a single row. Selectors 304 can allow a user to display additional icons 302 (when there are additional selections or commands to be displayed). Icons 306 and 308 are referenced below with respect to FIG. 5.

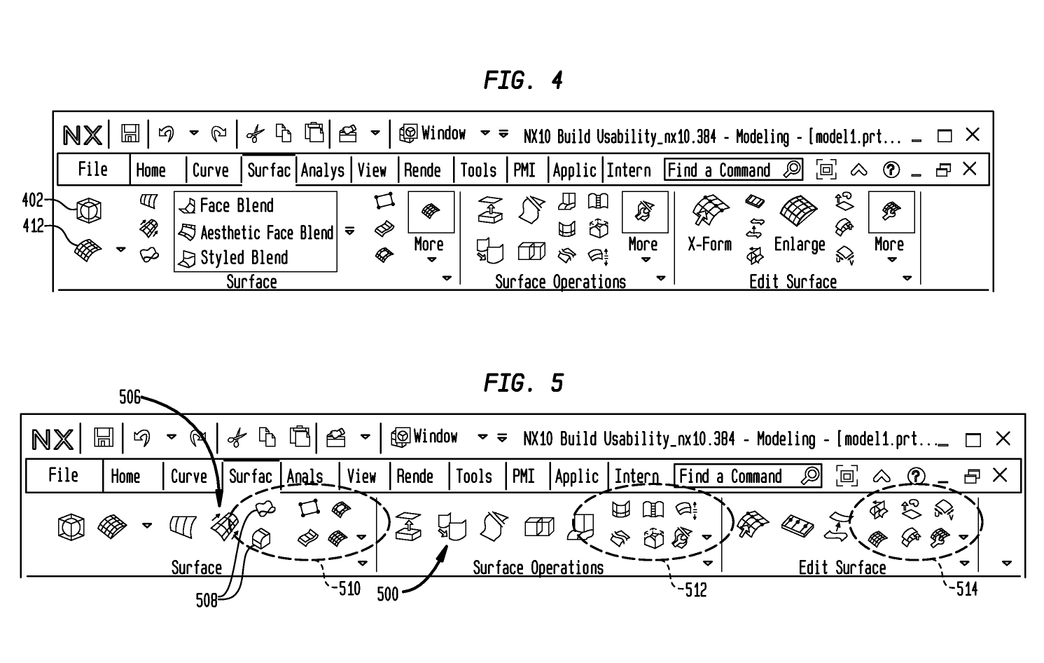

FIG. 4 illustrates an embodiment of a full-size ribbon where the scaling reduces the icons so that they can be moved from one row to two, three, or more rows. Note, in this example, that the menu items 402 and 412, which correspond to menu items 202 and 212 of FIG. 2, are reduced in size, and so can be “stacked” in two rows instead of appearing beside each other in a single row. By reducing the size of the icons, the system can display them in multiple rows and so produce a more compact menu ribbon.

FIG. 5 illustrates an embodiment of a reduced-size slim ribbon 500, wherein the scaling reduces menu items from large icons to small icons in order to fit in the required reduced space, repositioning them if necessary. Note, in this example, that icon 506 of FIG. 5 remains the same size as icon 306 of FIG. 3. However, to conserve space, icons 508 of FIG. 5 are reduced in size and “stacked” in two rows as compared to icons 308 of FIG. 3, as shown at 510, 512, and 514.

Using these techniques, the system can always maintain the same number of icons in both the full-size ribbon and in the reduced-size slim ribbon. If two large icons do not fit in a reduced-size slim ribbon, the system can reduce them to two small icons and presented them in a single column (2 rows). Comparing FIGS. 3 and 5, note that in FIG. 5 the horizontal space is reduced so the icons are “squeezed” in order to fit.

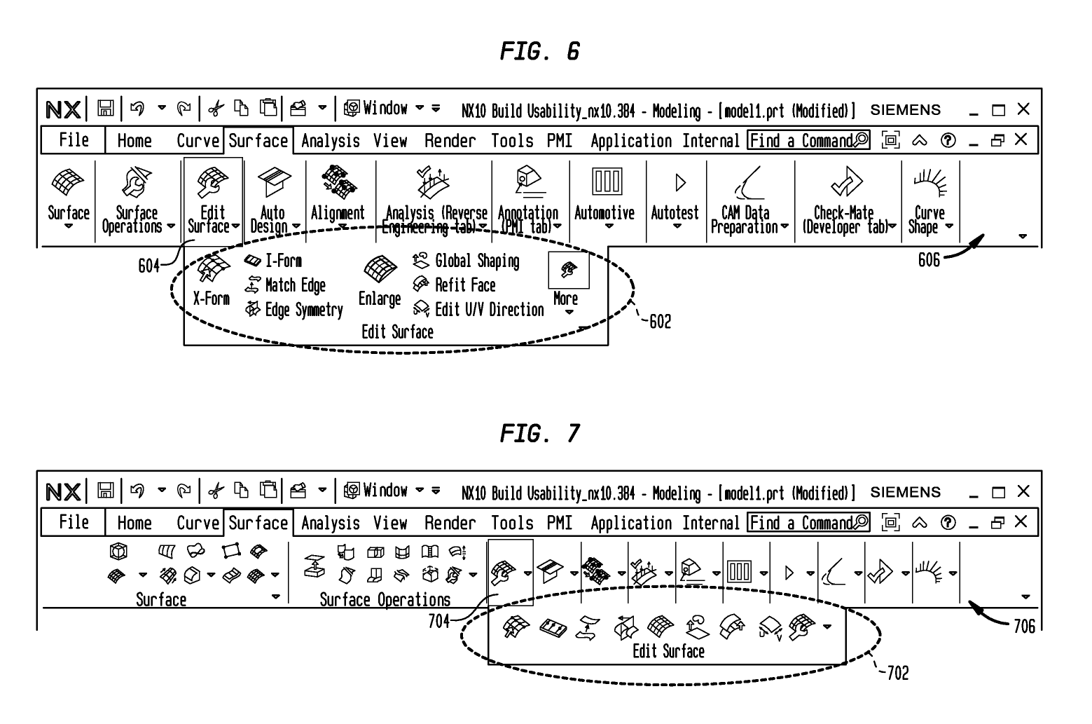

FIG. 6 illustrates an embodiment of a full-size ribbon where groups are collapsed to a single icon with a popup ribbon layout. In this figure, the group of menu items 602 is collapsed to be represented in the ribbon 606 by a single menu item referred to herein as a grouping icon 604. In response to a user selection of grouping icon 604, the group of menu items 602 is displayed; group of menu items 602 can be hidden at other times to save space on the reduced-size display. In this example, grouping icon 604 is represented as a large icon with a label, and each of the menu items in group of menu items 602 also includes both an icon and a label.

FIG. 7 illustrates an embodiment of a reduced-size slim ribbon wherein groups are collapsed to a single icon, with a popup also illustrated in a reduced-size slim ribbon layout. In this figure, the group of menu items 702 is collapsed to be represented in the ribbon 706 by a single menu item referred to herein as a grouping icon 704. In response to a user selection of grouping icon 704, the group of menu items 702 is displayed; group of menu items 702 can be hidden at other times to save space on the reduced-size display. In this example, grouping icon 704 is represented as a reduced-size icon with no label, as are each of the menu items in group of menu items 702. Note that even the “popup” group of menu items 702 maintains the same “reduced-size slim ribbon” logic as the groups in the top level ribbon. This can be seen by comparing group of menu items 602 in FIG. 6 with group of menu items 702 in FIG. 7, where group of menu items 702 has reduced size icons with no labels, in contrast to group of menu items 602.

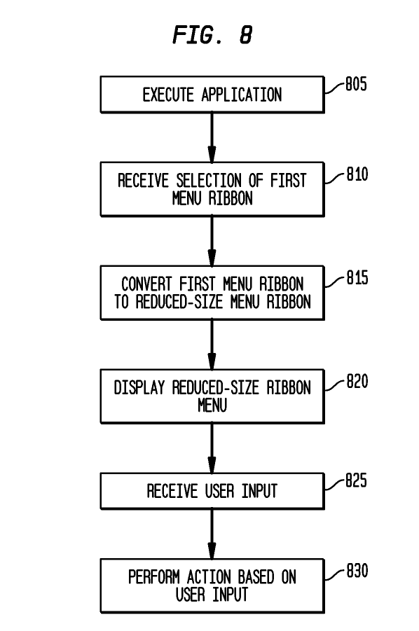

FIG. 8 illustrates a flowchart of a process in accordance with disclosed embodiments that can be performed, for example, by a data processing system 100, and in particular can be implemented in data processing systems with reduced-size displays, including laptop computers, tablet computers, smartphones, and other portable devices, any of which are referred to generically as the “system” below.

The system executes an application (805). The application can be, for example, a CAD application, word processing application, or any application that uses a menu ribbon touch interface as described herein, including the operating system application and interfaces.

The system receives a selection of a first menu ribbon to convert (810). The first menu ribbon can be, for example, a full-size menu ribbon such as menu ribbon 210. Receiving, as used herein can include loading from storage, receiving via another device or process, receiving via an interaction with a user, or otherwise. In specific embodiments, the selection can be received by one of several mechanisms, including but not limited to the user selecting a ribbon of the application to be reduced in size, the system selecting one or more ribbons based on one or more of a user-preference, pre-set configuration, or modification of the computer program window (such as a reduction in window size which automatically causes the ribbon to be selected), or otherwise. The system can optionally display the first menu ribbon.

The system converts the first menu ribbon to produce a reduced-size menu ribbon (815). In this process, the size of the first menu ribbon can be reduced. The reduced-size menu ribbon, such as reduced-size menu ribbon 500, can include the same command set and UI definition as the first menu ribbon, with changes in appearance, size, and grouping, for example, as described herein.

The system can convert the first menu ribbon in one or more of the following ways. The system can resize the first menu ribbon, dynamically switch menu items from a larger size to a smaller size, combine smaller menu items into columns with two or more rows, or adjust the size of all menu items uniformly based on the original pixel size, 100%, 150%, etc. In particular embodiments, no more than two rows are used, to conserve display space and keep a minimalistic presentation, although more rows are contemplated. The system can group menu items together as a menu ribbon width adjusts, resize menu items evenly across different groupings to maintain a consistent relative location, or collapse or expand groups of menu items depending on available layout space such that the menu items are reduced to a single item, such as a grouping icon, that displays a popup of the fully expanded representation and may include the title of the group at the bottom of the group. The system can position the menu ribbon content (commands, galleries, groups, or other elements) and ribbon tabs to show them centered. The system can inherit and reflect the original ribbon configuration of the first ribbon menu in the reduced-size menu ribbon. Each of these features can be selectively used in the conversion according to a system determination on how to fit the first menu ribbon into the reduced space of the second menu ribbon, preferably without removing any command or feature options. For example, in some cases, it may be sufficient to simply reduce the size of the menu items to convert to the reduced-size menu ribbon, but in other cases, with even smaller displays, it may also be necessary to group multiple menu items together to “pop-up” under a grouping icon.

The system displays the reduced-size menu ribbon in the application (820). The system can switch between a reduced-size menu ribbon and the first menu ribbon at will and can store or retrieve a ribbon view choice in a user preference profile.

The system can receive a user input in the reduced-size menu ribbon (825). The user input can include a command or function to be performed by the application, or can be a selection of a grouping icon in the reduced-size menu ribbon, or otherwise.

The system can perform an action in response to the user input (830). This action can be the command or function selected to be performed by the application. In cases where the user input is a selection of a grouping icon in the reduced-size menu ribbon, the action can be displaying a group of menu items, in the reduced-size menu ribbon, that corresponds to the grouping icon.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure are not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method performed by a data processing system, comprising:
executing an application;
receiving a selection of a first menu ribbon to convert;
converting the first menu ribbon to produce a reduced-size menu ribbon;
displaying the reduced-size menu ribbon in the application.

2. The method of claim 1, wherein the data processing system also receives a user input in the reduced-size menu ribbon and performs an action in response to the user input.

3. The method of claim 2, wherein the user input is a selection of a grouping icon in the reduced-size menu ribbon and the action is displaying a group of menu items, in the reduced-size menu ribbon, that corresponds to the grouping icon.

4. The method of claim 1, wherein converting the first menu ribbon includes at least one of resizing the first menu ribbon, dynamically switching menu items from a larger size to a smaller size, combining smaller menu items into columns with two or more rows, or adjusting the size of all menu items uniformly based on the original pixel size.

5. The method of claim 1, wherein converting the first menu ribbon includes at least one of grouping menu items together as a menu ribbon width adjusts, resizing menu items evenly across different groupings to maintain a consistent relative location, or collapsing or expanding groups of menu items depending on available layout space such that the menu items are reduced to a grouping icon.

6. The method of claim 1, wherein converting the first menu ribbon includes at least one of positioning content of the reduced-size menu ribbon to show them centered, or inheriting and reflecting an original ribbon configuration of the first ribbon menu in the reduced-size menu ribbon.

7. The method of claim 1, wherein the reduced-size menu ribbon includes the same command set and user interface definition as the first menu ribbon, with changes in appearance, size, or grouping.

8. A data processing system comprising:
a processor;
an accessible memory; and
a display, the data processing system particularly configured to execute an application;
receive a selection of a first menu ribbon to convert;
convert the first menu ribbon to produce a reduced-size menu ribbon;
display the reduced-size menu ribbon in the application.

9. The data processing system of claim 8, wherein the data processing system also receives a user input in the reduced-size menu ribbon and performs an action in response to the user input.

10. The data processing system of claim 9, wherein the user input is a selection of a grouping icon in the reduced-size menu ribbon and the action is displaying a group of menu items, in the reduced-size menu ribbon, that corresponds to the grouping icon.

11. The data processing system of claim 8, wherein converting the first menu ribbon includes at least one of resizing the first menu ribbon, dynamically switching menu items from a larger size to a smaller size, combining smaller menu items into columns with two or more rows, or adjusting the size of all menu items uniformly based on the original pixel size.

12. The data processing system of claim 8, wherein converting the first menu ribbon includes at least one of grouping menu items together as a menu ribbon width adjusts, resizing menu items evenly across different groupings to maintain a consistent relative location, or collapsing or expanding groups of menu items depending on available layout space such that the menu items are reduced to a grouping icon.

13. The data processing system of claim 8, wherein converting the first menu ribbon includes at least one of positioning content of the reduced-size menu ribbon to show them centered, or inheriting and reflecting an original ribbon configuration of the first ribbon menu in the reduced-size menu ribbon.

14. The data processing system of claim 8, wherein the reduced-size menu ribbon includes the same command set and user interface definition as the first menu ribbon, with changes in appearance, size, or grouping.

15. A non-transitory computer-readable medium encoded with executable instructions that, when executed, cause one or more data processing systems to:
execute an application;
receive a selection of a first menu ribbon to convert;
convert the first menu ribbon to produce a reduced-size menu ribbon;
display the reduced-size menu ribbon in the application.

16. The computer-readable medium of claim 15, wherein the data processing system also receives a user input in the reduced-size menu ribbon and performs an action in response to the user input.

17. The computer-readable medium of claim 16, wherein the user input is a selection of a grouping icon in the reduced-size menu ribbon and the action is displaying a group of menu items, in the reduced-size menu ribbon, that corresponds to the grouping icon.

18. The computer-readable medium of claim 15, wherein converting the first menu ribbon includes at least one of resizing the first menu ribbon, dynamically switching menu items from a larger size to a smaller size, combining smaller menu items into columns with two or more rows, or adjusting the size of all menu items uniformly based on the original pixel size.

19. The computer-readable medium of claim 15, wherein converting the first menu ribbon includes at least one of grouping menu items together as a menu ribbon width adjusts, resizing menu items evenly across different groupings to maintain a consistent relative location, or collapsing or expanding groups of menu items depending on available layout space such that the menu items are reduced to a grouping icon.

20. The computer-readable medium of claim 15, wherein converting the first menu ribbon includes at least one of positioning content of the reduced-size menu ribbon to show them centered, or inheriting and reflecting an original ribbon configuration of the first ribbon menu in the reduced-size menu ribbon.
